(19) United States
(12) Patent Application Publication
(10) Pub. No.: US 2012/0135374 A1
(43) Pub. Date: May 31, 2012

(54) Emergence Profile Guide for a Dental Bur

(76) Inventor: Dana Alan Carlton, Westlake Village, CA (US)

(21) Appl. No.: 13/364,813

(22) Filed: Feb. 2, 2012

Related U.S. Application Data
(63) Continuation-in-part of application No. 13/022,272, filed on Feb. 7, 2011.
Application No. 13/022,272 is a continuation of application No. 12/155,581, filed on Jun. 6, 2008.
Application No. 12/155,581 is a continuation of application No. 11/476,987, filed on Jun. 27, 2006, now abandoned.

(51) Int. Cl. A61C 8/00

(52) U.S. Cl. 433/75

(57) ABSTRACT

There are disclosed apparatus and method for obtaining a proper emergence profile for a dental implant. An emergence profile guide may be seated into an osteotomy and a dental bur may be guided onto and along the emergence profile guide. The emergence profile guide may include a pilot, and the dental bur may include a corresponding channel, such that the channel rides onto the pilot. The dental bur is stopped by the emergence profile guide, such that a countersink is created with an optimum depth.

### RELATED APPLICATION INFORMATION

This patent is a continuation-in-part of application Ser. No. 13/022,272 filed Feb. 7, 2011, which is incorporated herein by reference. Application Ser. No. 13/022,272 is a continuation of application Ser. No. 12/155,581 filed Jun. 6, 2008. Application Ser. No. 12/155,581 is a continuation of application Ser. No. 11/476,987 filed Jun. 27, 2006, now abandoned.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to apparatus and methods for installation of dental implants.

2. Description of the Related Art

This patent uses some relative terms, such as: “front”, “forward”, “back”, “rear”, “top”, “bottom”, “rearward”, “upper”, “lower”, “uppermost”, “lowermost”. These terms are used herein relative to a patient's mouth when the patient's head is upright, and from the perspective of someone looking at the mouth. From a different perspective these relative terms necessarily would change correspondingly.

Teeth are normally disposed in the upper jaw and lower jaw. The descriptions in this patent are with respect to the lower jaw. The descriptions apply equally to the upper jaw, though terms relative to vertical orientation are reversed between the upper jaw and lower jaw. The descriptions are made with respect to a human, though they apply also to other mammals.

A normal tooth has a root and a crown, formed of four types of tissue—enamel, dentin, pulp and cementum. The root of a normal tooth is embedded within and stabilized by the medullary bone. A highly specialized connective tissue, the periodontal ligament, is situated between the tooth and the medullary bone and in typical humans has a thickness between 0.1 mm and 1 mm. A normal tooth is also connected to masticatory mucosa, connective tissue, muscle and cortical bone.

The cortical bone covers the medullary bone. The cortical bone normally has a thickness ranging between 0.5 mm and 5 mm, and typically in humans between 1 mm and 3 mm. The cortical bone, the medullary bone and the adjacent tissue components are collectively called the dental ridge.

A paper-thin layer of tissue called periosteum lies between the cortical bone and the connective tissue. Oral mucosa covers the cortical bone and the root of the tooth. Gum tissue, which includes the alveolar mucosa, the masticatory mucosa and the connective tissue, normally ranges between 0.5 mm and 6 mm in thickness, and typically in humans between 1 mm and 4 mm.

The enamel covers the exposed portion of the tooth, also known as the tooth crown. The enamel is hard with a thickness between 0.5 mm and 3 mm, and typically in humans between 1 mm and 2 mm, depending on the particular individual tooth.

Inside of the enamel is a tissue called dentin. The dentin forms the bulk of the tooth and supports the enamel. The dentin is hard and elastic, with a thickness normally ranging between 0.5 mm and 3 mm, and in humans typically between 1 mm and 2 mm. The central portion of the tooth, enclosed by the dentin, is filled with a soft connective tissue, blood vessels, and nerve fibers called pulp. A hard and bonelike tissue called cementum covers the root of the tooth. The cementum is a mineralized connective tissue very similar to bone except that the cementum is avascular.

Dental prostheses are used in the practice of dentistry to replace teeth that have become unserviceable and/or painful to the patient due to disease or physical damage. A typical dental prosthetic has three main components—an implant, an abutment and a restoration. The restoration is either a crown, a bridge or a denture.

The implant typically is made of titanium or zirconium and has a threaded cylindrical bottom portion that is screwed into a drilled and tapped hole in the jawbone, and a typically conically tapered top portion (wider at the top and narrowing to the bottom portion) that extends to the level of the bone or to below the outer surface of the gum tissue. The point where the typical bottom portion flares outward to join the inward flare of the top portion is the implant margin. Typical implants are either unitary or in two parts where the top portion and the bottom portion are distinct. For some implants, the cylindrical bottom portion is tapered, being slightly smaller in diameter at the bottom. Regular diameter implants have a typical diameter of 3.5 to 6.0 mm. Narrow implants have a diameter of 3.0 to 3.5 mm. Mini diameter implants have a diameter of 1.8 to 3.0 mm.

The abutment typically has a tapered post at the top and a threaded cylindrical bottom portion that screws into an axial blind threaded hole in the top of the implant. For anchoring dentures or bridges, the abutment may be in the form of a ball (attached to a threaded shaft) or other geometric shape.

The crown is usually a metal-porcelain composite prosthesis that is attached to the top of the abutment, typically by means of a dental adhesive. To obtain an impression for making the crown, an impression cap is snapped onto, or is otherwise installed on, the implant margin, which, to be accessible, must be within the soft tissue (gum) rather than flush with or below the surface of the cortical layer of the jawbone.

Ideally, the bottom edge of the crown extends below the gum surface so that the metallic abutment and implant are not visible. However, this typically requires considerable talent to achieve because of the vagaries of the mouth, jaw and teeth, and the differences in nature between the restoration and the natural tissue, plus the presence of other items in the mouth.

Proper vertical positioning of the implant with respect to depth in the hole in the jawbone is important. The implant margin should be positioned beneath the gum level. The crown should be attached at the optimum functional height (relative to other teeth) without removing gum tissue and without leaving an aesthetically unpleasing gap between the gum and crown. The implant margin should also protrude sufficiently above the cortical bone to enable installation of an impression cap (without an additional surgical procedure), as well as formation of a smooth emergence profile for the crown relative to that of the implant collar.

The emergence profile is the axial contour of a tooth or crown as it relates to the adjacent soft tissue. The typical implant has a circular cross-section. The cross-section of a natural tooth subgingivally is definitely not circular. A crown typically is made with a natural emergence profile by adding porcelain subgingivally (i.e., below the gum line). This transforms the nearly perfectly circular outer surface of the implant into a more tooth-like profile by the time it emerges from the gingiva. If the cross-section of crown was a circle, the restoration would not have a normal tooth contour, trap food and debris more easily, and then not look normal if any gingiva were to recede.

The nature of the patient's gum tissue impacts the implant procedure and ultimate success. This gum tissue includes papillae, which are pyramidal shapes of tissue that fill the spaces in the areas beneath where teeth contact each other. The volume and height of bone between adjacent teeth controls the height of the papillae. If bone is lost on either side of an implant against a natural tooth, there is a poor chance of having a normal papilla filling the spaces between teeth, leading to what is sometimes referred to as black hole disease, or spaces between teeth.

Thicker gum tissues are more robust and resilient, easier to work with surgically and, better at hiding margins of restorations. Thin tissues are more delicate to work with surgically, tending to recede and are more see-through, making it difficult to hide, for example, the metal margin of an underlying implant or other implant crown materials. Thus it is more difficult to achieve an excellent aesthetic result with genetically thin tissue than it is with thicker tissue types.

The emergence profile involves both the implant shape and how far it is placed below the bone and gum tissues relative to the adjacent teeth. To obtain a good (i.e., natural) emergence profile in many cases, at least part of the conically tapered portion of the implant should fit into a countersunk area in the jawbone hole. The extent to which countersinking is practical for available implant sizes depends on the thickness of the bone and gum tissue, which varies significantly from person to person, and from site to site within the mouth.

In many countries, including the United States, there is no recognized specialty for dental implants. Likewise, in many countries there is no legally required certification for implant surgery. Though formal training is available, there is a wide variety in the skill sets and abilities of implant surgeons.

A dental bur is a type of burr (cutter) used in a dental handpiece, including implant surgery. Dental burs are usually made of tungsten carbide or diamond and are therefore very hard, which is necessary for cutting and grinding hard tooth tissue. The three parts to a dental bur are the head, the neck, and the shank. There are various shapes of dental burs that include round, inverted cone, straight fissure, tapered fissure, and pear-shaped dental burs. The head of the dental bur contains the blades which remove material. There is a wide array of different dental burs. Numbering systems to categorize dental burs include a US numbering system and a numbering system used by the International Organisation for Standardisation (ISO).

Drilling into a jawbone for an implant usually occurs in several separate steps. First a pilot hole is drilled, and then expanded by using progressively wider drills. The implant part can be a self-tapping screw, screwed into place at a precise torque. Because a drill tip is typically conical, the actual bottom of the osteotomy (i.e., drilled hole) is typically a bit deeper by about 1 mm.

### DESCRIPTION OF THE DRAWINGS

FIG. 1 is an elevated perspective view of a lower jaw and an emergence profile guide for a dental bur.

FIG. 2 is a sectional side view of a portion of the lower jaw and the emergence profile guide.

FIG. 3 is a side view of an emergence profile guide in combination with a dental bur.

FIG. 4 is a top view of the emergence profile guide.

FIG. 5 is a perspective view of another emergence profile guide.

FIG. 6 is a perspective view of another emergence profile guide.

Throughout this description, elements appearing in figures are assigned three-digit reference designators. An element that is not described in conjunction with a figure may be presumed to have the same characteristics and function as a previously-described element having a reference designator with the same least significant digits.

### DETAILED DESCRIPTION

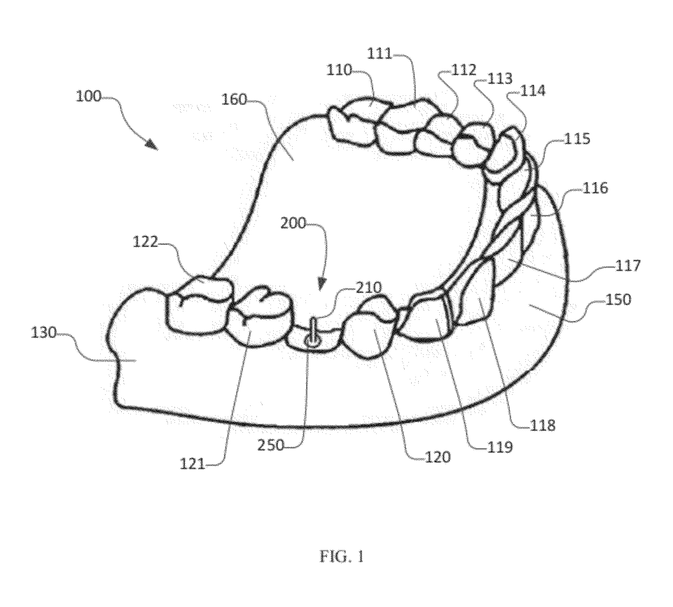

Referring now to FIG. 1 there is shown a lower jaw 100. An emergence profile guide 200 for a dental bur (not shown) is partially disposed in the lower jaw 100 and hidden by surrounding tissue.

The lower jaw 100 comprises a palate 130 with a plurality of teeth 110-122 embedded therein. The number and nature of the teeth 110-122 depends on the patient. The lower jaw 100 further includes facial gum tissue 150 and lingual gum tissue 160. The facial gum tissue 15 and the lingual gum tissue 160 are soft but resilient, and may be cut or incised, reflected, and sutured in dental surgical procedures.

The emergence profile guide 200 includes a pilot 210, and a base 250 which is mostly hidden in this view.

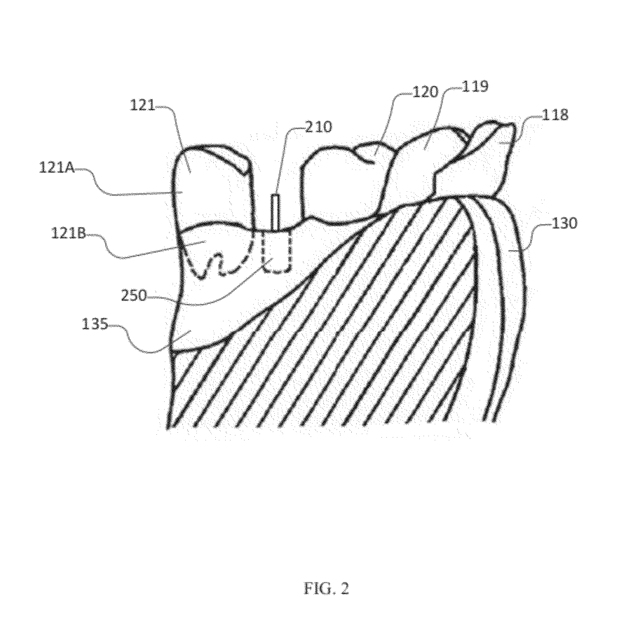

Referring now to FIG. 2, the palate 130 includes a medullary bone 135. Each tooth has a crown and a root, and these are shown particularly with respect to tooth 121 as crown 121A and root 121B. The root 121B is shown by dashed lines because it is hidden in this view. The root 121B is embedded within the medullary bone 135.

The base 250 of the emergence profile guide 200 fits snugly into a hole in the medullary bone 135. The base 250 is shown by dashed lines because it is hidden in this view by the medullary bone 135.

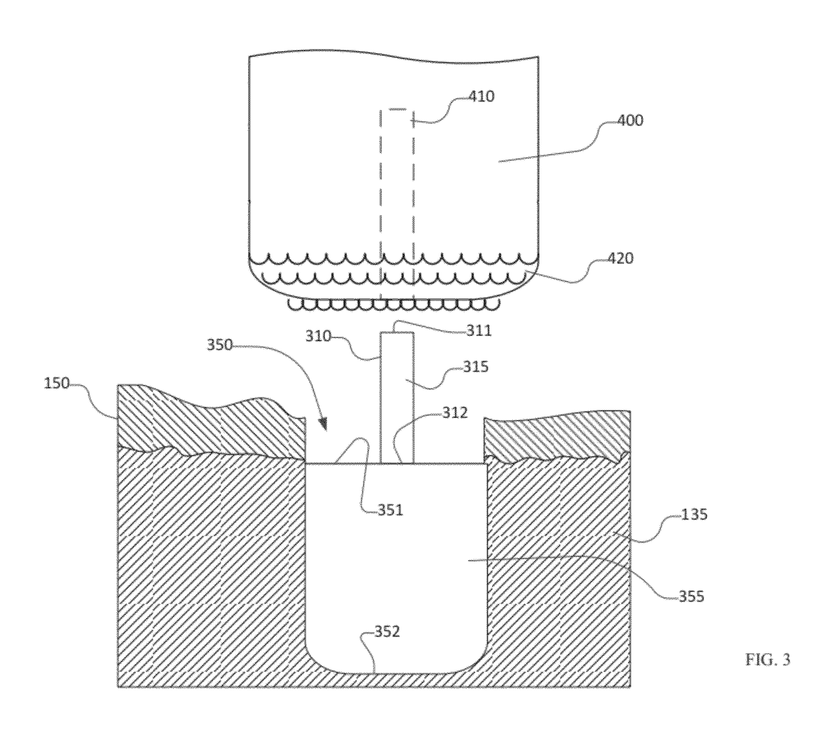

Referring now to FIG. 3 there is shown a side view of an emergence profile guide 300 for a dental bur, which may be the emergence profile guide 200 of FIG. 1 and FIG. 2. The emergence profile guide 300 has two primary components, a pilot 310 and a base 350. The base 350 is shown seated in an osteotomy in the medullary bone 135. The osteotomy is the hole which extends into the medullary bone 135 and through the facial gum tissue 150 and the lingual gum tissue (hidden from view by the facial gum tissue 150). The hole is the type formed by a dental drill and made in preparation for the installation of a dental implant.

Before the implant is installed, however, the emergence profile guide 300 may be used in concert with a dental bur 400 to create a proper emergence profile in the facial gum tissue 150 and the lingual gum tissue. The dental bur 400 may be a countersink bur with a cutting edge 420 which in a single application will cut away sufficient amount of the gum tissue to obtain an appropriate emergence profile. The dental bur 400 includes a cylindrical channel 410 from the end of the cutting surface 420 through and parallel to the body of the dental bur 400. The use of the dental bur 400 with the emergence profile guide 300 is explained below.

The base 350 has a main body 355 with a cylindrical shape with smooth walls. The base 350 further includes a top end 351 and a bottom end 352. The top end 351 may be flat and perpendicular to the main body 355.

The main body should fit snugly into the osteotomy, but not so snugly that it is difficult to remove. To match the osteotomy for a regular diameter implant, the main body 355 has a diameter of between 3.5 to 6.0 mm. To match a narrow implant, the main body 355 has a diameter of 3.0 to 3.5 mm. To match a mini diameter implant, the main body 355 has a diameter of 1.8 to 3.0 mm. The bottom end 352 of the base 350 may be outwardly rounded to seat firmly into the concave shape of the bottom of the osteotomy. For an osteotomy with a differently shaped bottom, the bottom end 352 may have a shape adapted to maximize the seating of the base 350 in the osteotomy. Depending on the patient's situation, the base may or may not seat at the bottom of the osteotomy. If there is no bone at the bottom of the osteotomy, bone can be grafted or added, in which case the implant will press the grafted or added bone into place, for example by lifting the sinus membrane.

The pilot 310 has a main body 315 with a cylindrical shape with smooth walls. The pilot 310 further includes a top end 311 and a bottom end 312. The bottom end 312 is connected to the base 350, and the top end 311 of the pilot 310 is free (i.e., extends outwardly and is not connected to anything other than the main body 315). The bottom end 312 of the pilot 310 is securely attached or attachable to the base 350 such that the cylindrical shape of the main body 315 of the pilot 310 is coaxial with the cylindrical shape of the main body 355 of the base 350. The pilot 310 may be permanently attached to the base 350, or it may be possible to join and/or separate the parts 310, 350. So that the dental bur 400 can ride smoothly up and down the length of the pilot's main body 315, the main body 315 has a diameter slightly smaller than the diameter of the channel 410. The pilot 310 should be sufficiently secured to the base 350 such that when the dental bur 400 is riding along the pilot 310, the pilot 310 will not separate from the base 350.

The emergence profile guide 300 may be formed of a single material or a variety of materials, depending on the requirements of its respective parts. These parts may be rigid metal, metallic, metal-like, ceramic, and/or composite. If multi-use capable, the emergence profile guide 300 should be sterilizable. For example, the main body 355 may have rigidity comparable to that of hard dental tissue to seat securely in the osteotomy. The first end of the base 350 should be structurally resistant to wear from a rotating dental bur pressing into the base 350. Alternatively, the length of the channel in the dental bur and the length of the pilot 310 may be sized such that the dental bur is stopped from riding too far down the pilot 310.

The emergence profile guide 300 may be removed from the osteotomy by firmly gripping the pilot 310 and lifting up and away from the hole. The pilot 310 may be grasped by hand or with a grasping too. To ease this process the pilot 310 may include a channel (not shown) running across the main body 315 perpendicular to the linear length of the main body 315. A soft member such as dental floss may be threaded into the channel and then used to lift the emergence profile guide 300. A hard member may be used as an alternative.

The emergence profile guide 300 may be combined with one or more complementary dental burs to form a kit.

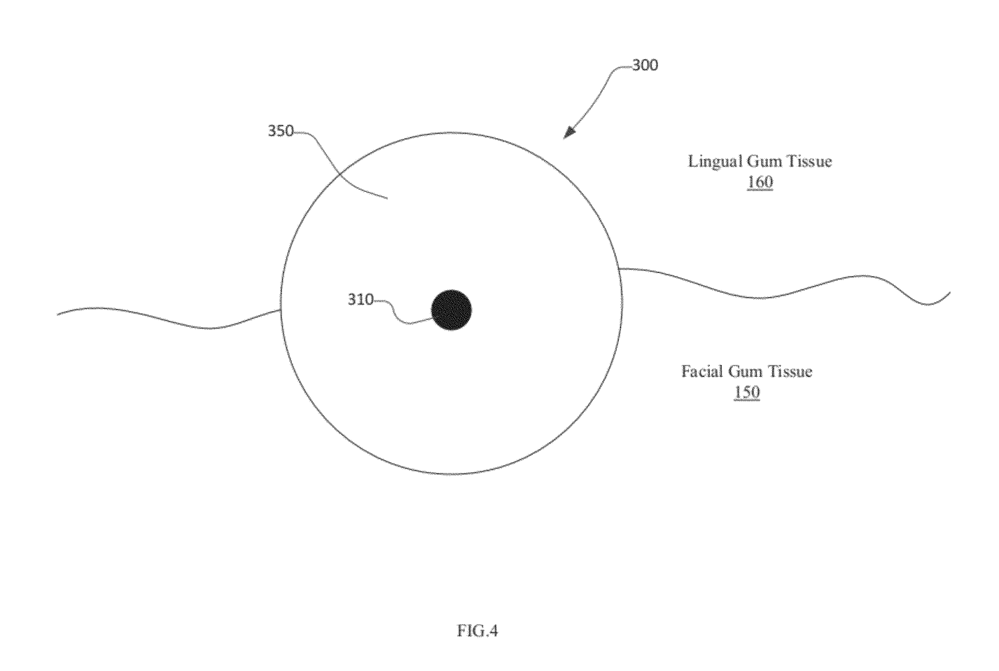

Referring now to FIG. 4 there is shown a top view of the emergence profile guide 300 shown surrounded by lingual gum tissue 160 and facial gum tissue 150.

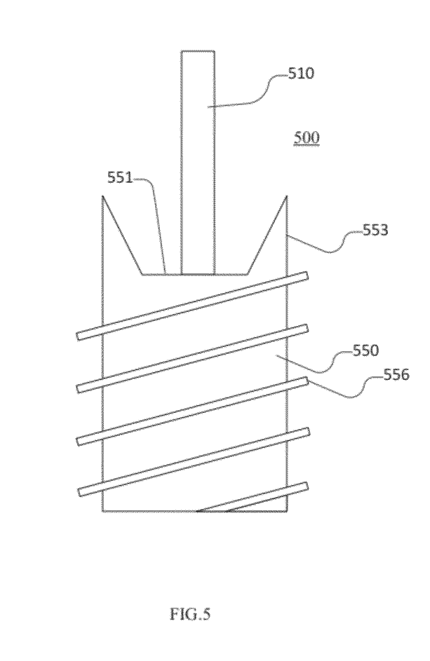

FIG. 5 shows a perspective view of another emergence profile guide 500. The emergence profile guide 500 is identical to the emergence profile guide 300 of FIG. 3 except in the following respects.

The emergence profile guide 500 includes threads 556 along and around the main body 555. The emergence profile guide 500 may be screwed into an osteotomy to provide a more stable platform for the dental bur. The threads 556 may be substantially the same as threads of an implant, or may be slightly less so as to minimize impact on medullary bone tissue.

The base 550 also include an extended portion 553 which may extend the circumference of the top end 551 of the base 550. This shape may be desirable for use with a dental bur with an angular lower end.

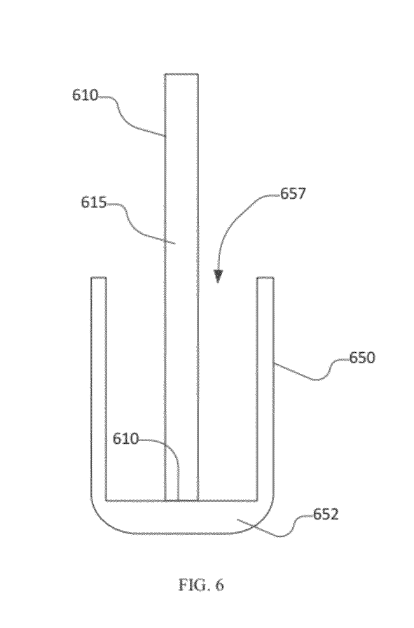

FIG. 6 is a cut-away side of view of another emergence profile guide 600. The emergence profile guide 600 is identical to the emergence profile bur guide 300 of FIG. 3 except in the following respects. The main body 655 of the base 650 has a hollow 657, and the main body 615 of the pilot 610 extends through the hollow 657 and the bottom end 612 of the pilot 610 is disposed within the main body 655 of the base 650 and attached to the bottom end 652 of the base 650.

The emergence profile guides and dental burs as described above are useful for ensuring that a dental implant will be installed in a hole in the jawbone at a predetermined vertical position on the first attempt, and that a desired emergence profile of bone will be created so that a properly shaped crown installed on the implant will be attained.

Procedures for using an emergence profile guide such as the emergence profile guides 200, 300, 500, 500 are as follows.

First, as described in my application Ser. No. 13/022,272, a hole though the gum tissue if flapless, and into the jawbone may be formed. The implant osteotomies are done. A vertical positioning device is utilized. The emergence profile drill is utilized. The positioning device is re-checked. The use of the profile drill and positioning device is repeated until proper positioning and emergence profile are obtained.

Next the emergence profile guide may be seated into the osteotomy. Next a dental bur having a channel and with a cutting size appropriate for the desired emergence profile may be positioned over the pilot of the emergence profile guide. Next the dental bur may be spun around the pilot and moved down along the pilot until the dental bur is stopped by the emergence profile guide. The dental bur may then be pulled back away from the pilot. Then the emergence profile guide may be removed from the hole. This process results in the desired emergence profile.

The emergence profile guide and countersink bur may be incorporated in a computer aided implant placement system to improve precision and efficiency. This involves creating a virtual system in the computer for planning and guiding the surgical procedure. The computerized implant positioning system may be used in both clinical and non-clinical laboratory applications.

In the clinical computerized implant placement system, the emergence profile guide and countersink bur are first duplicated in size and form using a two- and/or three-dimensional graphic-style computer program. These virtual devices are then used to plan and prepare clinical cases. The hard and soft tissues are virtually visualized based on a three-dimensional radiographic reconstruction of CT data, or data from another imaging method, ultrasound imaging, for example. Prior to the three-dimensional imaging, opaque (or equivalent) references are placed in or on the patient. The information obtained using the references and three-dimensional scans is then used to plan and perform computer-aided surgery.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. Apparatus comprising an emergence profile guide comprising:
(a) a base having a main body with a cylindrical shape with smooth walls, and first and second ends, wherein:
the main body of the base has a diameter of between 1.8 mm and 6.0 mm,
the main body of the base is formed of a material having a rigidity comparable to that of hard dental tissue,
the first end of the base is structurally resistant to wear from a dental bur;
(b) a pilot having a main body a cylindrical shape with smooth walls, and first and second ends, wherein:
the main body of the pilot has a diameter,
the first end of the pilot is free,
the second end of the pilot is securely attached or attachable to the base such that the cylindrical shape of the pilot is coaxial with the cylindrical shape of the main body of the base.

2. The apparatus of claim 1 wherein the second end of the base is outwardly rounded.

3. The apparatus of claim 1 wherein the main body of the base has smooth walls.

4. The apparatus of claim 3, further comprising threads along and around the main body.

5. The apparatus of claim 1 wherein the first end of the base is flat and perpendicular to the main body of the base.

6. The apparatus of claim 5 wherein the second end of the pilot is attached to the first end of the base.

7. The apparatus of claim 1 wherein the main body of the base has a hollow, and the main body of the pilot extends through the hollow and the second end of the pilot is disposed within the main body of the base and attached to the second end of the base.

8. The apparatus of claim 1 further comprising a dental bur, the dental bur having an elongate body and a channel running into the body, wherein the channel has a cross-sectional diameter slightly larger than the diameter of the main body of the pilot.
